(19) United States
(12) Patent Application Publication
(10) Pub. No.: US 2012/0312281 A1
(43) Pub. Date: Dec. 13, 2012

(54) EVAPORATED FUEL TREATMENT APPARATUS

(75) Inventors: Hidetoshi TSUTSUMI, Chiryu-shi (JP); Yuji TAKASHIMA, Toyota-shi (JP); Kensuke NAGAO, Nagoya-shi (JP)

(73) Assignee: AISAN KOGYO KABUSHIKI KAISHA, Obu-shi (JP)

(21) Appl. No.: 13/488,763

(22) Filed: Jun. 5, 2012

(30) Foreign Application Priority Data
Jun. 13, 2011 (JP) 2011-130918

(51) Int. Cl. F02M 33/06

(52) U.S. Cl. 123/519

(57) ABSTRACT

An evaporated fuel treatment apparatus is mounted in a vehicle having an engine, a fuel tank storing fuel for the engine, and a battery, the evaporated fuel treatment apparatus adsorbing evaporated fuel in the fuel tank on an adsorbent in a canister container, desorbing the evaporated fuel adsorbed on the adsorbent therefrom during engine running, and directing the evaporated fuel to an intake passage of the engine. The adsorbent in the canister is heated by heat generated by the battery.

### CROSS-REFERENCE TO RELATED APPLICATIONS

The present application claims priority under 35 U.S.C. §119 of Japanese Application No. 2011-130918, filed on Jun. 13, 2011, which is herein expressly incorporated by reference in its entirety.

### BACKGROUND OF THE INVENTION

1. Field of the Invention

The present invention relates to an evaporated fuel treatment apparatus that adsorbs evaporated fuel in a fuel tank of a vehicle on an adsorbent in a canister, desorbs the evaporated fuel adsorbed on the adsorbent therefrom during engine running, and directs the evaporated fuel to an intake passage of the engine.

2. Description of Related Art

A related conventional evaporated fuel treatment apparatus is disclosed in Related Art 1. The evaporated fuel treatment apparatus directs air heated by an engine into a canister container such that evaporated fuel adsorbed on an adsorbent is purged by the air. Since the evaporated fuel is purged by hot air, the adsorbent is prevented from being cooled by evaporation heat and efficiency is enhanced in desorbing the evaporated fuel from the adsorbent. The evaporated fuel desorbed from the adsorbent is directed to an intake passage of the engine together with the hot air and then burned again in the engine.

[Related Art 1] Japanese Utility Model Patent Laid-open Publication No. H4-100057

In the evaporated fuel treatment apparatus above, the air heated by the engine is directed into the canister container. Thus, hot air cannot be directed into the canister container at engine start, for instance, since the engine is cool. Accordingly, the evaporated fuel adsorbed on the adsorbent is purged by air at normal temperature at engine start, thus decreasing the efficiency in desorbing the evaporated fuel.

### SUMMARY OF THE INVENTION

In view of the circumstances above, the present invention is provided to heat an adsorbent in a canister during engine stop so as to enhance efficiency in desorbing evaporated fuel from the adsorbent even at engine start.

An aspect of the present invention provides an evaporated fuel treatment apparatus mounted in a vehicle having an engine, a fuel tank storing fuel of the engine, and a battery, the evaporated fuel treatment apparatus adsorbing evaporated fuel in the fuel tank on an adsorbent in a canister container, desorbing the evaporated fuel adsorbed on the adsorbent therefrom during engine running, and directing the evaporated fuel to an intake passage of the engine. The adsorbent in the canister is heated by heat of the battery.

According to the present invention, the adsorbent in the canister is heated by the heat of the battery. Thus, even during engine stop, for example, the adsorbent in the canister can be heated when the battery is used. Thereby, the warm adsorbent can be purged by air even at engine start, enhancing efficiency in desorbing the evaporated fuel.

Another aspect of the present invention provides the evaporated fuel treatment apparatus, in which air heated by the heat of the battery is directed into the canister container to heat the adsorbent. Another aspect of the present invention provides the evaporated fuel treatment apparatus, in which the battery is housed in a battery container and air in the battery container is directed into the canister container. Accordingly, the air heated by the heat of the battery is directed into the canister container, effectively heating the adsorbent.

Another aspect of the present invention provides the evaporated fuel treatment apparatus, in which the heat of the battery is transferred from the canister container to the adsorbent therein. Another aspect of the present invention provides the evaporated fuel treatment apparatus, in which the canister container and the battery container are integrated in a state of being partitioned by a metal plate. Another aspect of the present invention provides the evaporated fuel treatment apparatus, in which a pipe exhausting the air in the battery container is disposed in a position where the heat is transferrable to the adsorbent. Accordingly, the canister container is heated by the heat of the battery, and thus the adsorbent can be heated even when the air is not directed to the canister container.

According to the present invention, the canister is heated even during engine stop, enhancing efficiency in removing the evaporated fuel from the canister even at engine start.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a schematic view illustrating an entire configuration of an evaporated fuel treatment apparatus according to a first embodiment of the present invention and operations of the evaporated fuel treatment apparatus when a vehicle is not in use;

FIG. 2 is a schematic view illustrating operations of the evaporated fuel treatment apparatus of the first embodiment when the vehicle is travelling (during engine running);

FIG. 3 is a schematic view illustrating operations of the evaporated fuel treatment apparatus of the first embodiment when the vehicle is travelling (during engine stop);

FIG. 4 is a schematic view illustrating an entire configuration of an evaporated fuel treatment apparatus according to a second embodiment of the present invention and operations of the evaporated fuel treatment apparatus when a vehicle is not in use;

FIG. 5 is a schematic view illustrating operations of the evaporated fuel treatment apparatus of the second embodiment when the vehicle is travelling (during engine running); and

FIG. 6 is a schematic view illustrating operations of the evaporated fuel treatment apparatus of the second embodiment when the vehicle is travelling (during engine stop).

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### First Embodiment

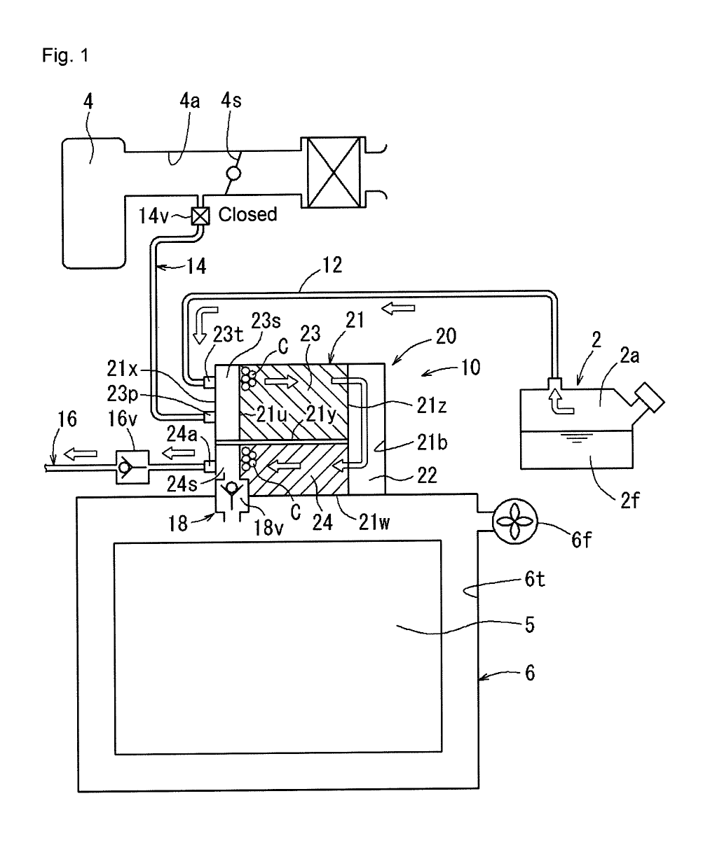

An evaporated fuel treatment apparatus according to a first embodiment of the present invention is described below with reference to FIGS. 1 to 3. The evaporated fuel treatment apparatus according to the present embodiment is mounted in a hybrid vehicle that has an engine and a motor as a drive source.

<Entire Configuration of Evaporated Fuel Treatment Apparatus 10>

An evaporated fuel treatment apparatus 10 has a canister 20, an evaporated fuel passage 12, a purge passage 14, an air passage 16, and a connecting passage 18. The canister 20 adsorbs vapor of fuel 2f (evaporated fuel) in a fuel tank 2. The evaporated fuel passage 12 directs the evaporated fuel in the fuel tank 2 to the canister 20. The purge passage 14 connects the canister 20 and an intake passage 4a of an engine 4. The air passage 16 emits air from the canister 20. The connecting passage 18 connects the canister 20 and a housing container 6 (battery container 6) of a battery 5.

<Canister 20>

With reference to FIG. 1, the canister 20 has a hermetically-sealed canister container 21 whose inside is divided into a plurality of portions. The canister container 21, which stores an adsorbent C of the evaporated fuel, is disposed on the battery container 6 in a lateral position such that the bottom is provided on the right side. The canister container 21 is divided into left and right portions by a filter-shaped vertical partition wall 21z at a position proximate to a bottom plate 21b. The right portion of the vertical partition wall 21z is provided as a diffusion space 22. The left portion of the vertical partition wall 21z is further divided by a horizontal wall 21y into a main chamber 23 in an upper portion and a sub-chamber 24 in a lower portion. The main chamber 23 and the sub-chamber 24 are filled with the adsorbent C. The adsorbent C is an activated carbon, which adsorbs the evaporated fuel and from which the adsorbed evaporated fuel is desorbable by air purge. Openings of the main chamber 23 and the sub-chamber 24 are closed by a filter-shaped inner cover vertical wall 21u after the adsorbent C is stored. A main chamber outer space 23s and a sub-chamber outer space 24s are provided in the left portion of the inner cover vertical wall 21u. Then, the main chamber outer space 23s and the sub-chamber outer space 24s are covered by a cover plate 21x of the canister container 21. A tank port 23t, a purge port 23p, and an air port 24a are provided in the cover plate 21x of the canister container 21. The tank port 23t and the purge port 23p are connected to the main chamber 23 through the main chamber outer space 23s and the inner cover vertical wall 21u. The air port 24a is connected to the sub-chamber 24 through the sub-chamber outer space 24s and the inner cover vertical wall 21u.

The evaporated fuel passage 12 is connected to the tank port 23t of the canister container 21 and to an upper air chamber 2a of the fuel tank 2. The purge passage 14 is connected to the purge port 23p of the canister container 21 and to an intake passage 4a positioned downstream of a throttle valve 4s of the engine 4 through a control valve 14v. The control valve 14v opens and closes a flow path of the purge passage 14 and operates based on an open/close signal from a control device (ECU). The air passage 16 is connected to the air port 24a of the canister container 21 and is provided with a check valve for emission 16v. The check valve for emission 16v opens a flow path when the inner pressure of the canister container 21 is greater than air pressure; otherwise, it closes the flow path. Specifically, the check valve for emission 16v allows air to exhaust from the canister container 21 and prevents outer air from flowing into the canister container 21.

The canister container 21 is disposed on the battery container 6 as described above. A lower plate 21w of the canister container 21 serves as a top plate of the battery container 6 as well. The lower plate 21w of the canister container 21 is composed of a steel plate, while the remaining portions of the canister container 21 are composed of a resin. Thus, the heat of the battery container 6 is readily transmitted to the adsorbent C in the canister 20 through the lower plate 21w of the canister container 21. As shown in FIG. 1, the lower plate 21w of the canister container 21 has a connection opening (reference numeral omitted) to which the connecting passage 18 is connected in the position of the sub-chamber outer space 24s. The connecting passage 18 connects the sub-chamber outer space 24s of the canister container 21 and the inner space of the battery container 6. The connecting passage 18 has a check valve for hot air inflow 18v. The check valve for hot air inflow 18v opens a flow path when the inner pressure of the battery container 6 is greater than the inner pressure of the canister container 21; otherwise, it closes the flow path. Specifically, the check valve for hot air inflow 18v allows air to flow from the battery container 6 to the canister container 21 but prevents air from flowing from the canister container 21 to the battery container 6.

<Battery Container 6>

The battery container 6 protects and cools the battery 5. The battery container 6 has a cooling fan 6f introducing outer air and a cooling passage 6t directing the air introduced by the cooling fan 6f to the vicinity of the battery 5. The connecting passage 18 is connected to an upper portion of the battery container 6 in a position proximate to a downstream end of the cooling passage 6t of the battery container 6, as shown in FIG. 1. A thermometer (not included in the drawing) is provided inside the cooling passage 6t of the battery container 6. A signal from the thermometer is input to the control device (ECU). The control device (ECU) outputs a drive signal to the cooling fan 6f when the temperature inside the cooling passage 6t exceeds approximately 40° C. With the cooling fan 6f driven, outer air flows into the cooling passage 6t of the battery container 6, thus air-cooling the battery 5 and increasing the inner pressure of the battery container 6. Accordingly, the air having removed the heat of the battery 5 (hot air) flows into the sub-chamber outer space 24s of the canister container 21 through the connecting passage 18 and the check valve for hot air inflow 18v.

<Operations of Evaporated Fuel Treatment Apparatus 10>

With reference to FIG. 1, operations of the evaporated fuel treatment apparatus 10 are described when a vehicle is not in use. The control valve 14v of the purge passage 14 is closed when the vehicle is not in use. Thus, the evaporated fuel generated in the fuel tank 2 is directed by the evaporated fuel passage 12 into the main chamber 23 through the tank port 23t of the canister container 21, as indicated with arrows in FIG. 1, and is adsorbed on the adsorbent C of the main chamber 23. The evaporated fuel not adsorbed on the adsorbent C of the main chamber 23 is directed to the sub-chamber 24 through the diffusion space 22, and is adsorbed on the adsorbent C of the sub-chamber 24. Then, the air inside the sub-chamber 24 of the canister container 21 is directed from the air port 24a to the air passage 16 and is emitted through the check valve for emission 16v. Specifically, the air from which the evaporated fuel has been removed is emitted. The check valve for hot air inflow 18v prevents the air from flowing from the canister container 21 to the battery container 6.

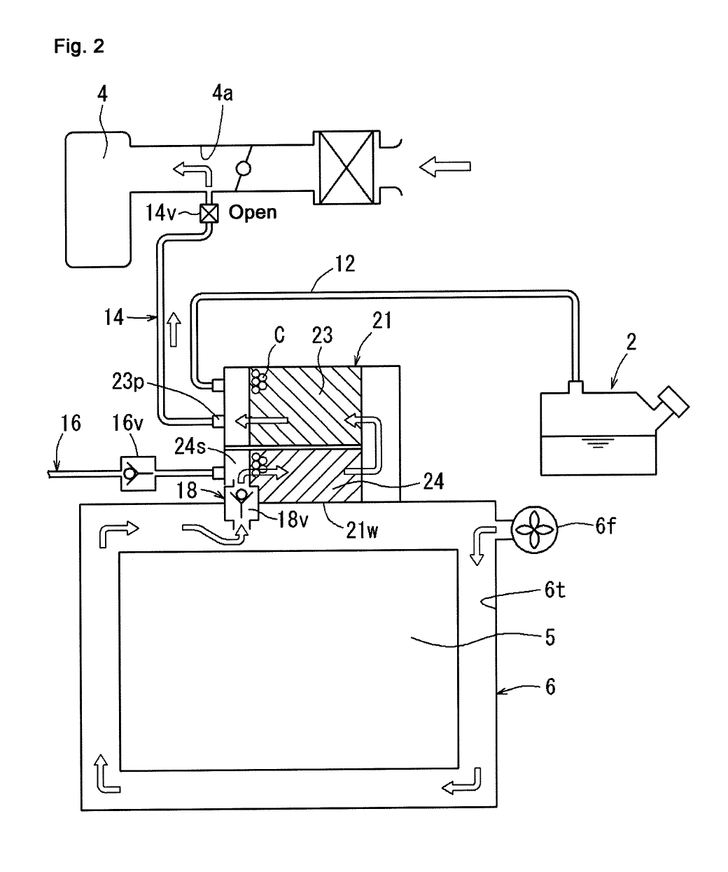

Operations of the evaporated fuel treatment apparatus 10 are described below when the vehicle is travelling. Since the vehicle is a hybrid vehicle, the engine 4 and a motor (not shown in the drawing) are used as a drive source. Thus, even when the engine 4 is stopped, the battery 5 generates heat, heating the battery container 6 and the air inside the cooling passage 6t of the battery container 6. The heat of the battery 5 is then transmitted from the battery container 6 to the adsorbent C in the canister container 21 through the steel lower panel 21w of the canister container 21. Thus, the adsorbent C is heated, improving efficiency in desorbing the evaporated fuel of the adsorbent C. The engine 4 of the vehicle is started in this state, and then, as shown in FIG. 2, the control valve 14v of the purge passage 14 is opened or closed in accordance with the signal from the control device (ECU).

With the open control valve 14v, the negative pressure of the engine 4 is exerted in the main chamber 23 and the sub-chamber 24 of the canister 20 through the purge passage 14, and the pressure inside the sub-chamber outer space 24s is changed to negative. Since the pressure inside the sub-chamber outer space 24s of the canister 20 is changed to negative, the pressure inside the canister container 21 is lower than the pressure inside the battery container 6. Thus, the check valve for hot air inflow 18v of the connecting passage 18 operates in the open direction. Since the pressure inside the canister container 21 is lower than atmospheric pressure, the check valve for emission 16v of the air passage 16 remains closed. Thus, the air (hot air) in the cooling path 6t of the battery container 6 is directed into the sub-chamber outer space 24s of the canister 20, as indicated with arrows in FIG. 2. Then, the air flows from the sub-chamber outer space 24s through the sub-chamber 24 and the main chamber 23 of the canister 20, and flows into the intake passage 4a (downstream side of the throttle valve 4s) of the engine 4 through the purge passage 14. Specifically, the adsorbent C is heated by the air (hot air) in the battery container 6 and is also purged thereby. Thus, the evaporated fuel adsorbed on the adsorbent C is desorbed therefrom and is directed into the intake passage 4a (downstream side of the throttle valve 4s) through the purge passage 14 together with the air (hot air).

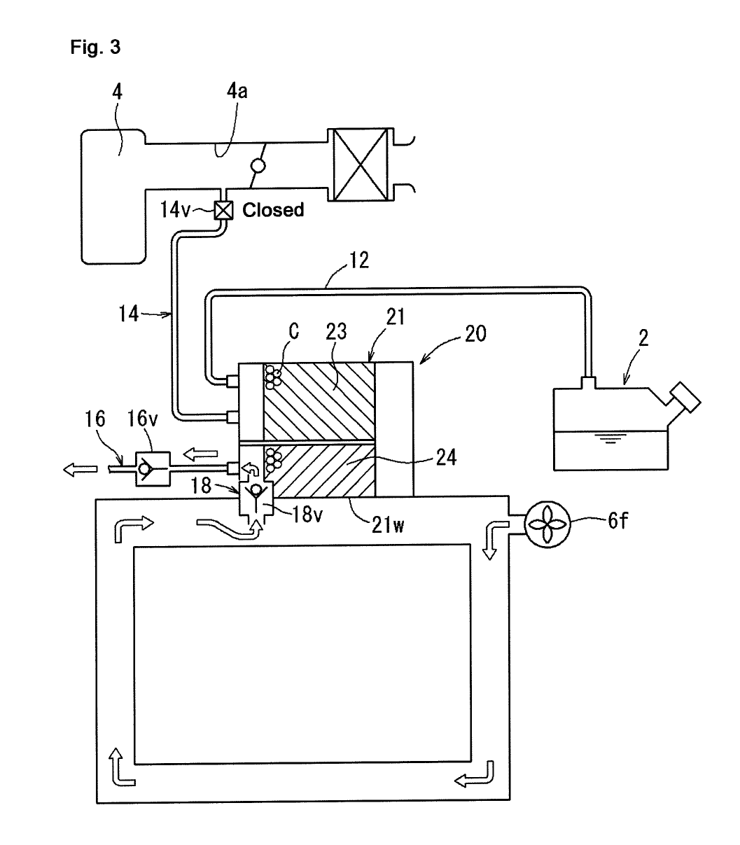

Subsequently, the engine 4 of the vehicle stops, and then, as shown in FIG. 3, the control valve 14v of the purge passage 14 is closed by the signal from the control device (ECU). Thus, the negative pressure of the engine 4 is no longer exerted in the canister 20. The pressure inside the battery container 6, however, is higher than the pressure inside the canister 20, and thus the check valve for hot air inflow 18v of the connecting passage 18 remains open. As indicated with arrows in FIG. 3, the air (hot air) in the battery container 6 is directed into the sub-chamber outer space 24s of the canister 20. Then, the pressure inside the sub-chamber outer space 24s of the canister 20 is changed to positive, and thus the check valve for emission 16v of the air passage 16 operates in the open direction. Accordingly, the air (hot air) in the sub-chamber outer space 24s of the canister 20 is emitted to outside through the air passage 16. Even in a case where the temperature inside the cooling passage 6t of the battery container 6 is increased and the cooling fan 6f operates, the air (hot air) in the cooling passage 6t of the battery container 6 is emitted to outside through the connecting passage 18, the sub-chamber outer space 24s of the canister 20, and the air passage 16.

<Advantages of Evaporated Fuel Treatment Apparatus 10>

According to the evaporated fuel treatment apparatus 10 of the present embodiment, the adsorbent C in the canister 20 is heated by the heat of the battery 5. Thus, even when the engine 4 is stopped, for example, the adsorbent C in the canister 20 can be heated when the battery 5 is used. Accordingly, even at a time when the engine 4 is started, the evaporated fuel adsorbed on the adsorbent C can be purged by hot air, thus enhancing efficiency in desorbing the evaporated fuel. In addition, the air in the battery container 6 is directed into the canister container 21, thus effectively heating the adsorbent C. Furthermore, the canister container 21 and the battery container 6 are integrated in a state where they are partitioned by the metal plate (steel plate), thus effectively heating the adsorbent C even when the air is not directed into the canister container 21.

### Second Embodiment

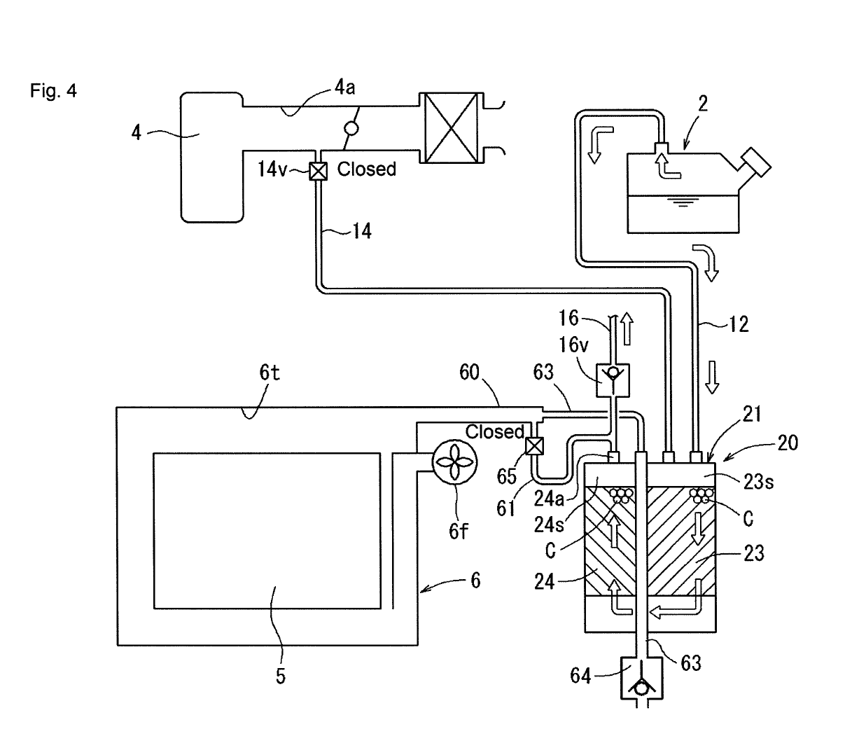

An evaporated fuel treatment apparatus according to a second embodiment of the present invention is described below with reference to FIGS. 4 to 6. In the evaporated fuel treatment apparatus according to the present embodiment, the battery container 6 and the canister 20 of the evaporated fuel treatment apparatus 10 in the first embodiment are disposed separately. Accordingly, a configuration in which the adsorbent C in the canister 20 is heated by the heat of the battery 5 is different from that in the evaporated fuel treatment apparatus 10 of the first embodiment. Configurations other than the above are similar in the evaporated fuel treatment apparatus 10 of the present embodiment and the evaporated fuel treatment apparatus 10 of the first embodiment. Thus, the configurations similar to those of the evaporated fuel treatment apparatus 10 of the first embodiment are denoted with the same reference numerals and their explanations are omitted.

In the battery container 6 of the evaporated fuel treatment apparatus according to the present embodiment, an exhaust pipe 60 is connected to a downstream end of the cooling passage 6t, and an end of the exhaust pipe 60 is split into a hot air supply pipe 61 and a thermal pipe 63, as shown in FIG. 4. The hot air supply pipe 61 is connected to the air port 24a of the canister 20 through the air passage 16 and is provided with a shutoff valve 65 that opens or closes in accordance with an open/close signal from the control device (ECU). The thermal pipe 63 of the exhaust pipe 60 is passed through a central portion of the canister container 21 so as to heat the adsorbent C in the canister container 21. It is preferred that the thermal pipe 63 be a metal pipe to facilitate heat transfer to the adsorbent C in the canister container 21. The thermal pipe 63 is also provided with a check valve 64 downstream of the canister container 21 to prevent inflow of atmospheric air.

Operations of the evaporated fuel treatment apparatus according to the present embodiment are described below. When a vehicle is not in use, the control valve 14v of the purge passage 14 and the shutoff valve 65 of the hot air supply pipe 61 are closed, as shown in FIG. 4. Thus, the evaporated fuel generated in the fuel tank 2 is directed by the evaporated fuel passage 12 to the main chamber 23 and the sub-chamber 24 of the canister 20, as indicated with arrows in FIG. 4, and is adsorbed on the adsorbent C in the main chamber 23 and the sub-chamber 24. Then, the air in the canister 20 is emitted from the sub-chamber outer space 24s through the air passage 16.

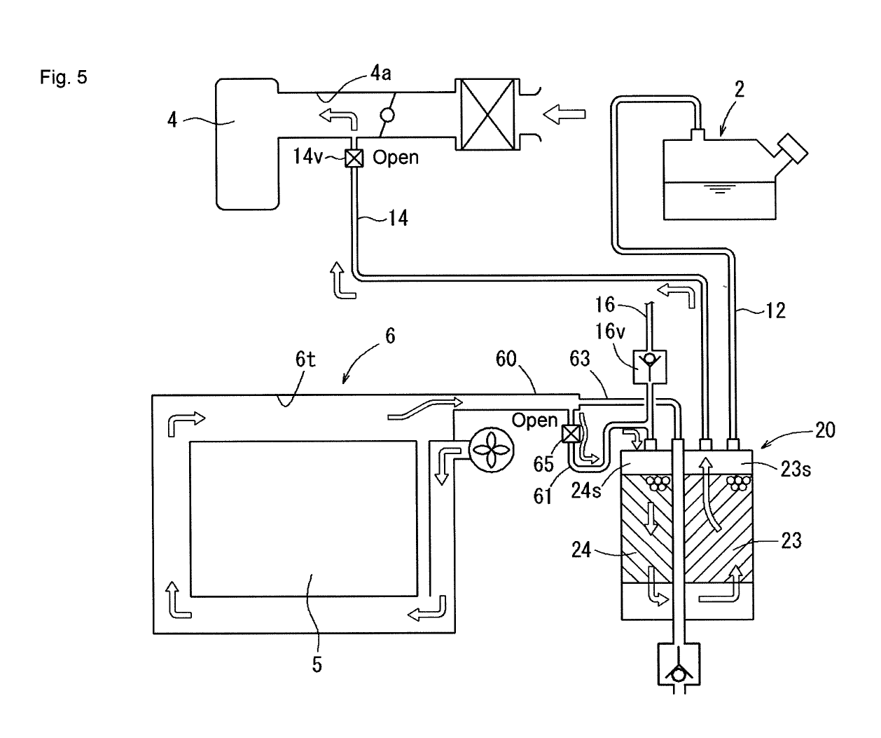

Subsequently, the engine 4 is driven, and then the control valve 14v of the purge passage 14 and the shutoff valve 65 of the hot air supply pipe 61 are opened by the signal from the control device (ECU), as shown in FIG. 5. Thus, the negative pressure of the engine 4 is exerted in the main chamber 23 and the sub-chamber 24 of the canister 20 through the purge passage 14. The air (hot air) in the battery container 6 flows into the canister 20 through the exhaust pipe 60, the shutoff valve 65, and the hot air supply pipe 61, as indicated with arrows in FIG. 5. Then, the air (hot air) flows through the sub-chamber 24 and the main chamber 23 of the canister 20 and flows into the intake passage 4a of the engine 4 through the purge passage 14. Thus, the evaporated fuel adsorbed on the adsorbent C is desorbed from the adsorbent C and is directed into the intake passage 4a through the purge passage 14 together with the air (hot air).

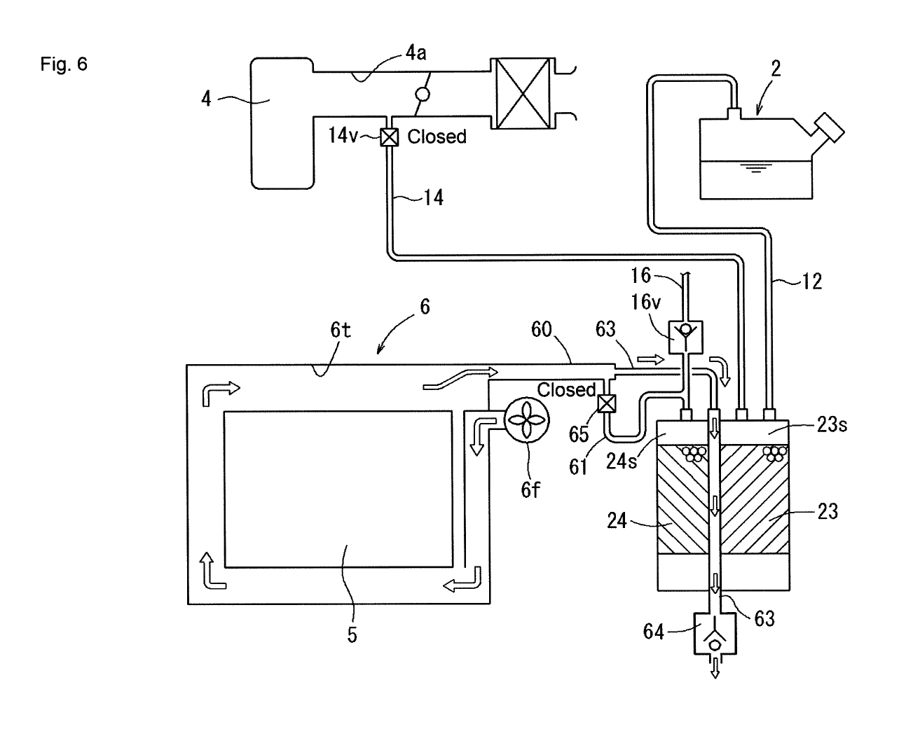

Subsequently, the engine 4 of the vehicle is stopped, and then the control valve 14v of the purge passage 14 and the shutoff valve 65 of the hot air supply pipe 61 are closed by the signal from the control device (ECU), as shown in FIG. 6. Thus, the air (hot air) in the cooling passage 6t of the battery container 6 is emitted to outside from the exhaust pipe 60 through the thermal pipe 63. Accordingly, the adsorbent C in the canister 20 is heated by the air (hot air) passing through the thermal pipe 63. With an increase in the temperature inside the cooling passage 6t of the battery container 6, the cooling fan 6f is activated, and then the air flow is increased through the thermal pipe 63 to effectively heat the adsorbent C.

<Modification>

The present invention is not limited to the first and second embodiments above, and may be modified without departing from the scope of the present invention. For example, the canister container 21 is disposed on the battery container 6 in the evaporated fuel treatment apparatus 10 of the first embodiment. Alternatively, a portion of the canister container 21 (e.g., the main chamber 23 and the sub-chamber 24) may be housed in the battery container 6. Furthermore, the thermal pipe 63 of the exhaust pipe 60 of the battery container 6 is passed through the central portion of the canister container 21 in the evaporated fuel treatment apparatus of the second embodiment. Alternatively, the thermal pipe 63 may be bent in a zigzag shape and passed through the canister container 21. The thermal pipe 63 may be split into a plurality of pipes and passed through the canister container 21. Furthermore, the thermal pipe 63 of the exhaust pipe 60 of the battery container 6 may be tightly attached to an exterior of the canister container 21 to heat the adsorbent C therein.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An evaporated fuel treatment apparatus mounted in a vehicle having an engine, a fuel tank storing fuel for the engine, and a battery, the evaporated fuel treatment apparatus including an adsorbent in a canister container, the evaporated fuel treatment apparatus being configured to adsorb evaporated fuel in the fuel tank on the adsorbent, desorb the evaporated fuel adsorbed on the adsorbent therefrom during engine running, and direct the evaporated fuel to an intake passage of the engine, wherein the adsorbent in the canister is heated by heat generated by the battery.

2. The evaporated fuel treatment apparatus according to claim 1, wherein air heated by the heat generated by the battery is directed into the canister container to heat the adsorbent.

3. The evaporated fuel treatment apparatus according to claim 2, wherein the battery is housed in a battery container and air in the battery container is directed into the canister container.

4. The evaporated fuel treatment apparatus according to claim 1, wherein the heat generated by the battery is transferred from the canister container to the adsorbent therein.

5. The evaporated fuel treatment apparatus according to claim 2, wherein the heat generated by the battery is transferred from the canister container to the adsorbent therein.

6. The evaporated fuel treatment apparatus according to claim 3, wherein the heat generated by the battery is transferred from the canister container to the adsorbent therein.

7. The evaporated fuel treatment apparatus according to claim 6, wherein the canister container and the battery container are adjacent each other and partitioned by a metal plate.

8. The evaporated fuel treatment apparatus according to claim 6, wherein a pipe exhausting the air from the battery container is disposed in a position where the heat is transferrable to the adsorbent.
